(19) United States
(12) Patent Application Publication
(10) Pub. No.: US 2017/0372842 A1
(43) Pub. Date: Dec. 28, 2017

(54) ELECTRO-POLARIZABLE COMPLEX COMPOUND AND CAPACITOR

(71) Applicant: Capacitor Sciences Incorporated, Menlo Park, CA (US)

(72) Inventors: Pavel Ivan Lazarev, Menlo Park, CA (US); Paul T. Furuta, Sunnyvale, CA (US); Barry K. Sharp, Redwood City, CA (US)

(21) Appl. No.: 15/194,224

(22) Filed: Jun. 27, 2016

(51) Int. Cl. H01G 9/025; C09D 7/12; C07F 5/00; H01G 9/048; H01G 9/15

(52) U.S. Cl. CPC H01G 9/025; H01G 9/048; H01G 9/15; C07F 5/003; C09D 7/1233; H01G 9/151

(57) ABSTRACT

The present disclosure provides an electro-polarizable complex compound having the following general formula:

[M⁴⁺(L)ₘ]^{x}Kₙ, (I)

where complexing agent M is a four-valence metal; ligand L comprises one or more heteroatomic fragments comprising one or more neutral or anionic metal-coordinating heteroatoms and one or more electrically resistive fragments, m represents the number of ligands; x represents the oxidative state of the metal-ligand complex; K is a counter-ion or zwitterionic polymers which provides an electro-neutrality of the complex compound, n represents the number of counter-ions. The metal-coordinating heteroatoms form a first coordination sphere, and the number of heteroatoms in this first coordination sphere does not exceed 12.

### FIELD OF THE INVENTION

The present disclosure relates generally to passive components of electrical circuit and more particularly to an electro-polarizable complex compound and capacitor based on this material and intended for energy storage.

### BACKGROUND

A capacitor is a passive electronic component that is used to store energy in the form of an electrostatic field, and comprises a pair of electrodes separated by a dielectric layer. When a potential difference exists between the two electrodes, an electric field is present in the dielectric layer. An ideal capacitor is characterized by a single constant value of capacitance, which is a ratio of the electric charge on each electrode to the potential difference between them. For high voltage applications, much larger capacitors have to be used.

One important characteristic of a dielectric material is its breakdown field. This corresponds to the value of electric field strength at which the material suffers a catastrophic failure and conducts electricity between the electrodes. For most capacitor geometries, the electric field in the dielectric can be approximated by the voltage between the two electrodes divided by the spacing between the electrodes, which is usually the thickness of the dielectric layer. Since the thickness is usually constant it is more common to refer to a breakdown voltage, rather than a breakdown field. There are a number of factors that can dramatically reduce the breakdown voltage. In particular, the geometry of the conductive electrodes is important factor affecting breakdown voltage for capacitor applications. In particular, sharp edges or points hugely increase the electric field strength locally and can lead to a local breakdown. Once a local breakdown starts at any point, the breakdown will quickly “trace” through the dielectric layer until it reaches the opposite electrode and causes a short circuit.

Breakdown of the dielectric layer usually occurs as follows. Intensity of an electric field becomes high enough to “pull” electrons from atoms of the dielectric material and makes them conduct an electric current from one electrode to another. Presence of impurities in the dielectric or imperfections of the crystal structure can result in an avalanche breakdown as observed in semiconductor devices.

Another of important characteristic of a dielectric material is its dielectric permittivity. Different types of dielectric materials are used for capacitors and include ceramics, polymer film, paper, and electrolytic capacitors of different kinds. The most widely used polymer film materials are polypropylene and polyester. Increasing dielectric permittivity allows for increasing volumetric energy density, which makes it an important technical task.

An ultra-high dielectric constant composite of polyaniline, PANI-DBSA/PAA, was synthesized using in situ polymerization of aniline in an aqueous dispersion of poly-acrylic acid (PAA) in the presence of dodecylbenzene sulfonate (DBSA) (see, Chao-Hsien Hoa et al., “High dielectric constant polyaniline/poly(acrylic acid) composites prepared by in situ polymerization”, Synthetic Metals, Vol. 158, pp. 630-637 (2008)), which is incorporated herein by reference. The water-soluble PAA served as a polymeric stabilizer, protecting the PANI particles from macroscopic aggregation. A very high dielectric constant of about 2.0·10⁵ (at 1 kHz) was obtained for the composite containing 30% PANI by weight. Influence of the PANI content on the morphological, dielectric and electrical properties of the composites was investigated. Frequency dependence of dielectric permittivity, dielectric loss, loss tangent and electric modulus were analyzed in the frequency range from 0.5 kHz to 10 MHz. SEM micrograph revealed that composites with high PANI content (i.e., 20 wt. %) consisted of numerous nano-scale PANI particles that were evenly distributed within the PAA matrix. High dielectric constants were attributed to the sum of the small capacitors of the PANI particles. The drawback of this material is a possible occurrence of percolation and formation of at least one continuous electrically conductive channel under electric field with probability of such an event increasing with an increase of the electric field. When at least one continuous electrically conductive channel (track) through the neighboring conducting PANI particles is formed between electrodes of the capacitor, it decreases a breakdown voltage of such capacitor.

Colloidal polyaniline particles stabilized with a water-soluble polymer, poly(N-vinylpyrrolidone) [poly(′-vinylpyrrolidin-2-one)], have been prepared by dispersion polymerization. The average particle size, 241±50 nm, have been determined by dynamic light scattering (see, Jaroslav Stejskal and Irina Sapurina, “Polyaniline: Thin Films and Colloidal Dispersions (IUPAC Technical Report)”, Pure and Applied Chemistry, Vol. 77, No. 5, pp. 815-826 (2005)), which is incorporated herein by reference.

Single crystals of doped aniline oligomers are produced via a simple solution-based self-assembly method (see, Yue Wang, et. al., “Morphological and Dimensional Control via Hierarchical Assembly of Doped Oligoaniline Single Crystals”, J. Am. Chem. Soc., Vol. 134, pp. 9251-9262 (2012)), which is incorporated herein by reference. Detailed mechanistic studies reveal that crystals of different morphologies and dimensions can be produced by a “bottom-up” hierarchical assembly where structures such as one-dimensional (1-D) nanofibers can be aggregated into higher order architectures. A large variety of crystalline nanostructures, including 1-D nanofibers and nanowires, 2-D nanoribbons and nanosheets, 3-D nanoplates, stacked sheets, nanoflowers, porous networks, hollow spheres, and twisted coils, can be obtained by controlling the nucleation of the crystals and the non-covalent interactions between the doped oligomers. These nanoscale crystals exhibit enhanced conductivity compared to their bulk counterparts as well as interesting structure-property relationships such as shape-dependent crystallinity. Furthermore, the morphology and dimension of these structures can be largely rationalized and predicted by monitoring molecule-solvent interactions via absorption studies. Using doped tetra-aniline as a model system, the results and strategies presented in this article provide insight into the general scheme of shape and size control for organic materials.

Thus, materials with high dielectric permittivity which are based on composite materials and containing polarized particles (such as PANI particles) may demonstrate a percolation phenomenon. The formed polycrystalline structure of layers has multiple tangling chemical bonds on borders between crystallites. When the used material with high dielectric permittivity possesses polycrystalline structure, a percolation may occur along the borders of crystal grains.

Hyper-electronic polarization of organic compounds is described in greater detail in Roger D. Hartman and Herbert A. Pohl, “Hyper-electronic Polarization in Macromolecular Solids”, Journal of Polymer Science: Part A-1, Vol. 6, pp. 1135-1152 (1968), which is incorporated herein by reference. Hyper-electronic polarization may be viewed as the electrical polarization external fields due to the pliant interaction with the charge pairs of excitons, in which the charges are molecularly separated and range over molecularly limited domains. In this article four polyacene quinone radical polymers were investigated. These polymers at 100 Hz had dielectric constants of 1800-2400, decreasing to about 58-100 at 100,000 Hz. Essential drawback of the described method of production of material is use of a high pressure (up to 20 kbars) for forming the samples intended for measurement of dielectric constants.

Influence of acrylic acid grafting of isotactic polypropylene on the dielectric properties of the polymer is investigated using density functional theory calculations, both in the molecular modeling and three-dimensional (3D) bulk periodic system frameworks (see, Henna Russka et al., “A Density Functional Study on Dielectric Properties of Acrylic Acid Crafted Polypropylene”, The Journal of Chemical Physics, Vol. 134, p. 134904 (2011)), which is incorporated herein by reference. The polarizability volume and polarizability volume per mass reflect the permittivity, and the HOMO-LUMO gap is one of the important measures indicating the electrical breakdown voltage strength. Therefore, calculation of polarizability volume and polarizability volume per mass as well as calculation of the HOMO-LUMO gap were executed by Henna Russka et al. in molecular modeling of oligomers with various chain lengths and carboxyl mixture ratios. The lowest unoccupied molecular orbital (LUMO) energies of a variety of molecular organic semiconductors have been evaluated using inverse photoelectron spectroscopy data and are compared with data determined from the optical energy gap, electrochemical reduction potentials, and density functional theory calculations (see, Peter I. Djuravich et al., “Measurement of the lowest unoccupied molecular orbital energies of molecular organic semiconductors”, Organic Electronics, Vol. 10, pp. 515-520 (2009)).

A capacitor is a passive electronic component that is used to store energy in the form of an electrostatic field, and comprises a pair of electrodes separated by a dielectric layer. When a potential difference exists between the two electrodes, an electric field is present in the dielectric layer.

One important characteristic of a dielectric material is its breakdown field. This corresponds to the value of electric field strength at which the material suffers a catastrophic failure and conducts electricity between the electrodes. For most capacitor geometries, the electric field in the dielectric can be approximated by the voltage between the two electrodes divided by the spacing between the electrodes, which is usually the thickness of the dielectric layer. Since the thickness is usually constant it is more common to refer to a breakdown voltage, rather than a breakdown field. Breakdown of the dielectric layer usually occurs as follows. Intensity of an electric field becomes high enough to “pull” electrons from atoms of the dielectric material and makes them conduct an electric current from one electrode to another. Presence of impurities in the dielectric or imperfections of the crystal structure can result in an avalanche breakdown as observed in semiconductor devices.

Another of important characteristic of a dielectric material is its dielectric permittivity. Different types of dielectric materials are used for capacitors and include ceramics, polymer film, paper, and electrolytic capacitors of different kinds. The most widely used polymer film materials are polypropylene and polyester. Increasing dielectric permittivity allows for increasing volumetric energy density, which makes it an important technical task.

An ultra-high dielectric constant composite of polyaniline, PANI-DBSA/PAA, was synthesized using in situ polymerization of aniline in an aqueous dispersion of poly-acrylic acid (PAA) in the presence of dodecylbenzene sulfonate (DBSA) (see, Chao-Hsien Hoa et al., “High dielectric constant polyaniline/poly(acrylic acid) composites prepared by in situ polymerization”, Synthetic Metals, Vol. 158, pp. 630-637 (2008)). The water-soluble PAA served as a polymeric stabilizer, protecting the PANI particles from macroscopic aggregation. A very high dielectric constant of about 2.0×10⁵ (at 1 kHz) was obtained for the composite containing 30% PANI by weight. Influence of the PANI content on the morphological, dielectric and electrical properties of the composites was investigated. Frequency dependence of dielectric permittivity, dielectric loss, loss tangent and electric modulus were analyzed in the frequency range from 0.5 kHz to 10 MHz. SEM micrograph revealed that composites with high PANI content (i.e., 20 wt. %) consisted of numerous nano-scale PANI particles that were evenly distributed within the PAA matrix. High dielectric constants were attributed to the sum of the small capacitors of the PANI particles. The drawback of this material is a possible occurrence of percolation and formation of at least one continuous electrically conductive channel under electric field with probability of such an event increasing with an increase of the electric field. When at least one continuous electrically conductive channel (track) through the neighboring conducting PANI particles is formed between electrodes of the capacitor, it decreases a breakdown voltage of such capacitor.

Colloidal polyaniline particles stabilized with a water-soluble polymer, poly(N-vinylpyrrolidone) [poly(1-vinylpyrrolidin-2-one)], have been prepared by dispersion polymerization. The average particle size, 241±50 nm, have been determined by dynamic light scattering (see, Jaroslav Stejskal and Irina Sapurina, “Polyaniline: Thin Films and Colloidal Dispersions (IUPAC Technical Report)”, Pure and Applied Chemistry, Vol. 77, No. 5, pp. 815-826 (2005), which is incorporated herein by reference.

Single crystals of doped aniline oligomers are produced via a simple solution-based self-assembly method (see, Yue Wang, et. al., “Morphological and Dimensional Control via Hierarchical Assembly of Doped Oligoaniline Single Crystals”, J. Am. Chem. Soc., Vol. 134, pp. 9251-9262 (2012)). Detailed mechanistic studies reveal that crystals of different morphologies and dimensions can be produced by a “bottom-up” hierarchical assembly where structures such as one-dimensional (1-D) nanofibers can be aggregated into higher order architectures. A large variety of crystalline nanostructures, including 1-D nanofibers and nanowires, 2-D nanoribbons and nanosheets, 3-D nanoplates, stacked sheets, nanoflowers, porous networks, hollow spheres, and twisted coils, can be obtained by controlling the nucleation of the crystals and the non-covalent interactions between the doped oligomers. These nanoscale crystals exhibit enhanced conductivity compared to their bulk counterparts as well as interesting structure-property relationships such as shape-dependent crystallinity. Furthermore, the morphology and dimension of these structures can be largely rationalized and predicted by monitoring molecule-solvent interactions via absorption studies. Using doped tetra-aniline as a model system, the results and strategies presented in this article provide insight into the general scheme of shape and size control for organic materials.

Thus, materials with high dielectric permittivity which are based on composite materials and containing polarized particles (such as PANI particles) may demonstrate a percolation phenomenon. The formed polycrystalline structure of layers has multiple tangling chemical bonds on borders between crystallites. When the used material with high dielectric permittivity possesses polycrystalline structure, a percolation may occur along the borders of crystal grains.

Hyper-electronic polarization of organic compounds is described in greater detail in Roger D. Hartman and Herbert A. Pohl, “Hyper-electronic Polarization in Macromolecular Solids”, Journal of Polymer Science: Part A-1, Vol. 6, pp. 1135-1152 (1968), which is incorporated herein by reference. Hyper-electronic polarization may be viewed as the electrical polarization external fields due to the pliant interaction with the charge pairs of excitons, in which the charges are molecularly separated and range over molecularly limited domains. In this article four polyacene quinone radical polymers were investigated. These polymers at 100 Hz had dielectric constants of 1800-2400, decreasing to about 58-100 at 100,000 Hz. Essential drawback of the described method of production of material is use of a high pressure (up to 20 kbars) for forming the samples intended for measurement of dielectric constants.

The lowest unoccupied molecular orbital (LUMO) energies of a variety of molecular organic semiconductors have been evaluated using inverse photoelectron spectroscopy data and are compared with data determined from the optical energy gap, electrochemical reduction potentials, and density functional theory calculations (see, Peter I. Djuravich et al., “Measurement of the lowest unoccupied molecular orbital energies of molecular organic semiconductors”, Organic Electronics, Vol. 10, pp. 515-520 (2009)).

Capacitors as energy storage device have well-known advantages versus electrochemical energy storage, e.g. a battery. Compared to batteries, capacitors are able to store energy with very high power density, i.e. charge/recharge rates, have long shelf life with little degradation, and can be charged and discharged (cycled) hundreds of thousands or millions of times. However, capacitors often do not store energy in small volume or weight as in case of a battery, or at low energy storage cost, which makes capacitors impractical for some applications, for example electric vehicles. Accordingly, it may be an advance in energy storage technology to provide capacitors of higher volumetric and mass energy storage density and lower cost.

Capacitors as energy storage device have well-known advantages versus electrochemical energy storage, e.g. a battery. Compared to batteries, capacitors are able to store energy with very high power density, i.e. charge/recharge rates, have long shelf life with little degradation, and can be charged and discharged (cycled) hundreds of thousands or millions of times. However, capacitors often do not store energy in small volume or weight as in case of a battery, or at low energy storage cost, which makes capacitors impractical for some applications, for example electric vehicles. Accordingly, it may be an advance in energy storage technology to provide capacitors of higher volumetric and mass energy storage density and lower cost.

### SUMMARY

The present disclosure provides an electro-polarizable complex compound having the following general formula:

[M⁴⁺(L)ₘ]^{x}Kₙ, (I)

where complexing agent M is a four-valence metal, ligand L comprises at least one heteroatomic fragment comprising at least one metal-coordinating heteroatom (neutral or anionic) and at least one electrically resistive fragment that provides resistivity to electric current, m represents the number of ligands, x represents the oxidative state of the metal-ligand complex, K is a counter-ion or zwitterionic polymer which provides an electro-neutrality of the complex compound, and n represents the number of counter-ions. The metal-coordinating heteroatoms form a first coordination sphere, and the number of heteroatoms in this first coordination sphere does not exceed 12.

In another aspect, the present disclosure provides a solution comprising an organic solvent and at least one electro-polarizable complex compound as disclosed above.

In still another aspect, the present disclosure provides a crystal meta-dielectric layer comprising a mixture of the electro-polarizable complex compounds as disclosed above. The polarizable atoms of the four-valence metals are placed into the resistive dielectric envelope formed by the electrically resistive fragments that are electrically resistive; where atoms of the four-valence metals, organic molecules of ligands, or heteroatoms have electronic or ionic type of polarizability.

In yet another aspect, the present disclosure provides a meta-capacitor comprising two metal electrodes positioned parallel to each other and which can be rolled or flat and planar and meta-dielectric layer between said electrodes. The layer comprises the electro-polarizable complex compounds as disclosed above. The polarizable atoms of the four-valence metals are placed into the resistive dielectric envelope formed by electrically resistive fragments where atoms of the four-valence metals, organic molecules of ligands, or heteroatoms have electronic or ionic type of polarizability.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

A more complete assessment of the present invention and its advantages will be readily achieved as the same becomes better understood by reference to the following detailed description, considered in connection with the accompanying drawings and detailed specification, all of which forms a part of the disclosure. Embodiments of the invention are illustrated, by way of example only, in the following Figures, of which:

FIG. 1A schematically shows one embodiment of disclosed electro-polarizable complex compound.

FIG. 1B schematically shows the electro-polarizable complex compound shown in FIG. 1A which is deformed under the influence of an external electrical field.

FIG. 2 schematically shows modified the electro-polarizable complex compound shown in FIG. 1A.

FIG. 3 schematically shows still another embodiment of disclosed electro-polarizable complex compound

FIG. 4A schematically shows the disclosed capacitor with flat and planar electrodes.

FIG. 4B schematically shows the disclosed capacitor with rolled (circular) electrodes.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Although the following detailed description contains many specific details for the purposes of illustration, anyone of ordinary skill in the art will appreciate that many variations and alterations to the following details are within the scope of the invention. Accordingly, the exemplary embodiments of the invention described below are set forth without any loss of generality to, and without imposing limitations upon, the claimed invention.

In the following detailed description, reference is made to the accompanying drawings, which form a part hereof, and in which is shown by way of illustration specific non-limiting embodiments in which the invention may be practiced. In this regard, directional terminology, such as “top,” “bottom,” “front,” “back,” “first,” “second,” etc., is used with reference to the orientation of the figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

Additionally, concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a thickness range of about 1 nm to about 200 nm should be interpreted to include not only the explicitly recited limits of about 1 nm and about 200 nm, but also to include individual sizes such as but not limited to 2 nm, 3 nm, 4 nm, and sub-ranges such as 10 nm to 50 nm, 20 nm to 100 nm, etc. that are within the recited limits.

The present disclosure provides an electro-polarizable complex compound as disclosed above. Essential distinctive feature of the present invention is existence of the electrically resistive fragments as ligands. These fragments create a resistive envelop around the complexing agent M and the first coordination sphere. The resistive envelop isolates the molecules of disclosed electro-polarizable complex compound from each other. In one embodiment of the electro-polarizable complex compound, the four-valence metal is selected from the set comprising cerium, thorium, lead, titanium, zirconium, tin, palladium, platinum, osmium, iridium, germanium, manganese, and hafnium. In another embodiment of the electro-polarizable complex compound, the electrically resistive fragment provides resistivity to electric current and comprises hydrocarbon (saturated and/or unsaturated), fluorocarbon, siloxane, and/or polyethylene glycol as linear or branched chains. In yet another embodiment of the present disclosure, the electrically resistive fragments are cross-linked. In still another embodiment of the present disclosure, the electrically resistive fragments are fluorinated. In one embodiment of the present disclosure, the counter-ion K is R₄, where R can be Fluorine (F) or an alkyl group. By way of example and not by way of limitation, the counter-ion or zwitterionic polymer K may be N⁺(C₄H₉)₄ or NH₄⁺. In another embodiment of the disclosed complex compound, the counter-ion is selected from one or multiple ionic groups from the class of ionic compounds that are used in ionic liquids are connected directly or via a connecting group to at least one ligand. In yet another embodiment of the disclosed complex compound, the at least one ionic group is selected from the list comprising [NR₄]⁺, [PR₄]⁺ as cation and [—CO₂]⁻, [—SO₃]⁻, [—SR₅]⁻, [—PO₃R]⁻, [—PR₅]⁻ as anion, wherein R is selected from the set comprising H, alkyl, and fluorine. In still another embodiment of the disclosed complex compound, the at least one connecting group is selected from the set comprising CH₂, CF₂, SiR₂O, CH₂CH₂O, wherein R is selected from the set comprising H, alkyl, and fluorine. In one embodiment of the present disclosure, at least one connecting group is selected from the list comprising the following structures 1-9 as shown in Table 1.

TABLE 1
Examples of the connecting group where X
can be hydrogen (H) or an alkyl group

| | |
|---|---|
| 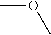 | 1 |
| 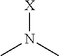 | 2 |
| 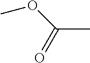 | 3 |
| 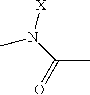 | 4 |
| 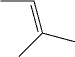 | 5 |
| —≡— | 6 |
| 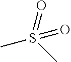 | 7 |
| 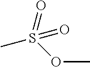 | 8 |
| 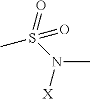 | 9 |

In another embodiment of the present disclosure, at least one connecting group is selected from the list comprising the following structures 11-16 as shown in Table 2.

TABLE 2
Examples of the connecting group

| | |
|---|---|
| 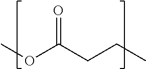 | 11 |
| 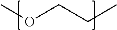 | 12 |
| 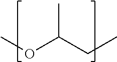 | 13 |
| 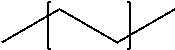 | 14 |
| 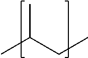 | 15 |
| 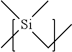 | 16 |

In one embodiment of the complex compound, the counter-ion is selected from one or multiple ionic groups from the class of ionic compounds that are zwitterionic polymers. In another embodiment of the complex compound, the zwitterionic polymer is N-Dodecyl-N,N-(dimethylammonio)butyrate having the following structural formula:

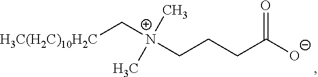

wherein two atoms of oxygen of carboxyl group take part in formation of the first coordination sphere and the cation N⁺ serves as the counter-ion.

In still another embodiment of the present disclosure, the complex compound has the following general formula:

Ce⁴⁺(Ste⁻)₄₊ₘ[N(but)⁺₄]ₘ, (II)

where m≧2; Ste is anion of stearic acid comprising atoms of oxygen as heteroatoms and an electrically resistive alkyl chain as the resistive fragment, a counter-ion N(but)⁺₄ is cation of tetrabutyl ammonium.

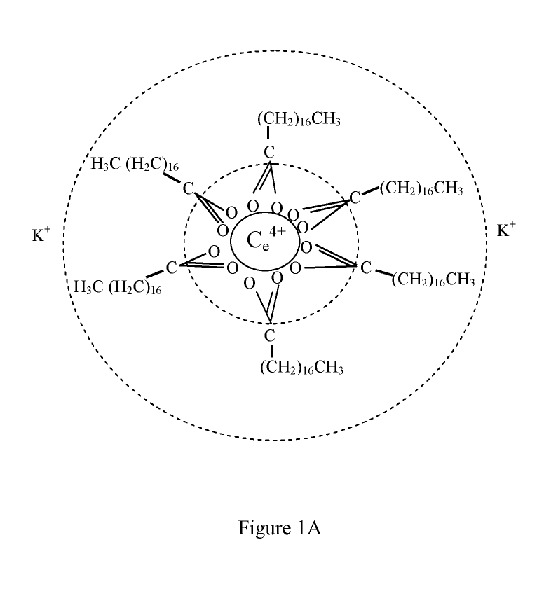

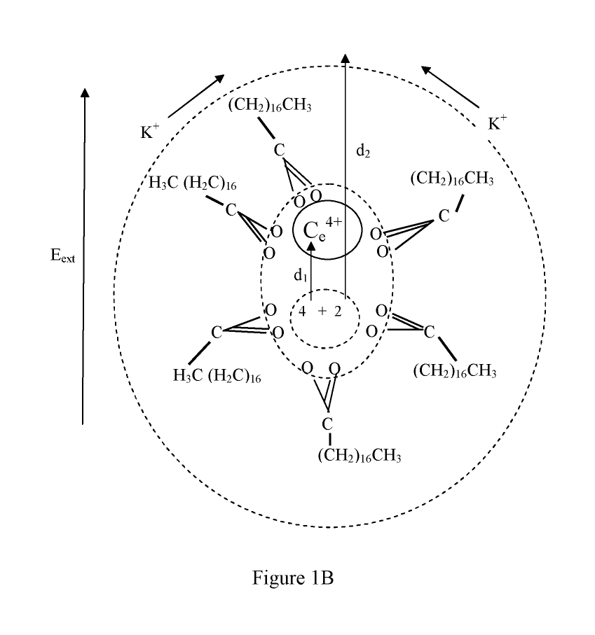

FIG. 1A schematically shows the spherical micelle created according to expression (II) when m=2. Six atoms of oxygen of the carboxylic groups of stearic acid form the first coordination sphere round the cerium atom. The first coordination sphere and atom of cerium form an ionic complex with a negative two charge. The resistive fragments (C(CH₂)₁₆CH₃) form the isolating spherical envelope located around the atom of cerium and the coordination sphere. The isolating spherical envelope is schematically depicted by two dotted circles represented in FIG. 1A. Two counter-ions (K⁺) provide an electro-neutrality of the complex compound and are situated outside the isolating envelope. The counter-ions are selected from tetrabutil ammonium (N⁺(C₄H₉)₄), ammonium (NH₄⁺) and one or multiple ionic groups from the class of ionic compounds that are used zwitterionic polymers or in ionic liquids. It is necessary to notice that in the declared compound some types of interaction are realized: coordination bond, ionic interaction and Van der Waals interaction.

FIG. 1B schematically shows one embodiment of the electro-polarizable complex compound shown in FIG. 1A which is deformed under the influence of an external electrical field. The atom of cerium (IV) is displaced in the direction of external electric field. The oxygen molecules forming the first coordination sphere are displaced under the influence of external electric field in an opposite direction. Thus, the first coordination sphere is deformed under the influence of external electric field as shown in FIG. 1B. Besides, the effective negative charge (which is equal to −6) of the first coordination sphere is displaced relative to positive charge of the ion (Ce⁺⁴) of cerium (IV). Part of a negative charge (which is equal to −4) of the first coordination sphere and the positive charge of the ion (Ce⁺⁴) of cerium (IV) form an electric dipole d1. Thus, this part of the reserved energy is formed by as a result of work of an external field against coordination bond. External electric field influences also onto the counter-ions and zwitterionic polymers. Under the influence of external electric field positively charged counter-ions and zwitterionic polymers are displaced in the direction of a field. Part of a negative charge (which is equal to −2) of the first coordination sphere and the positive charge (+2) of the counter-ions or zwitterionic polymers form an electric dipole d2. Thus, this part of the reserved energy is formed by as a result of work of an external field against ionic interaction.

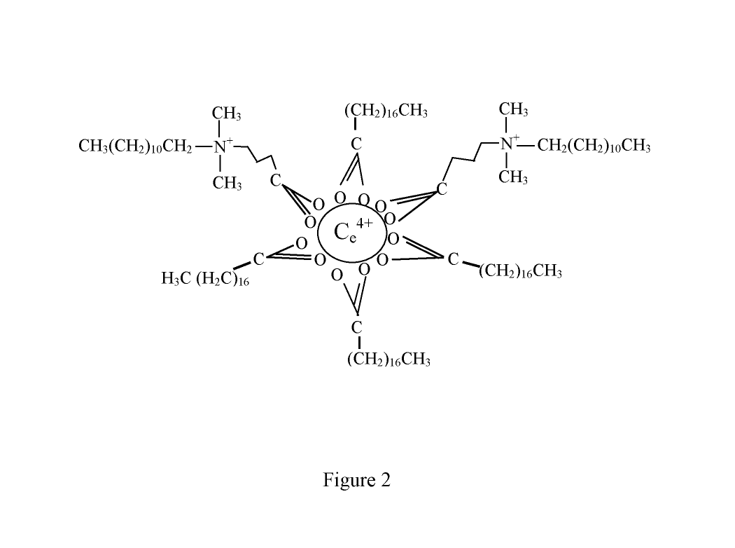

The molecular structure shown in FIG. 1A may be modified. For this zwitterion polymers such as DDMAB may be used to replace two stearates. The modified molecular structure is shown in FIG. 2 wherein two atoms of oxygen of carboxyl group take part in formation of the first coordination sphere and the cation N⁺ serves as the counter-ion.

In yet another embodiment of the present disclosure, the ligand L has the following general formula:

(R₁)ₖ-Core-(R₂)ₚ, (III)

where Core is an aromatic polycyclic conjugated anisotropic molecule, R₁ is an electrically resistive substituent that provides resistivity to electric current and comprises hydrocarbon (saturated and/or unsaturated), fluorocarbon, siloxane, and/or polyethylene glycol as linear or branched chains, R₂ is a substitute comprising at least one metal-coordinating heteroatom (neutral or anionic), k=1, 2, 3, and 4, p=1, 2, 3, 4, 5, 6, 7, and 8. Said aromatic polycyclic conjugated molecule (Core) forms supramolecules in the suitable solvent. In still another embodiment of the present disclosure in the general formula (III) the aromatic polycyclic conjugated molecule is a rylene fragment, R₁ is an electrically resistive substituent that provides resistivity to electric current and comprises hydrocarbon (saturated and/or unsaturated), fluorocarbon, siloxane, and/or polyethylene glycol as linear or branched chains located in terminal/apex positions, R₂ is a heteroatom functional group with at least one metal-coordinating heteroatom (neutral or anionic) located in lateral/bay positions. For an explanation of the used terms the structural formula of organic compound is shown below in which the substitutes R′ are located in terminal/apex positions and substitutes R″ are located in lateral/bay positions:

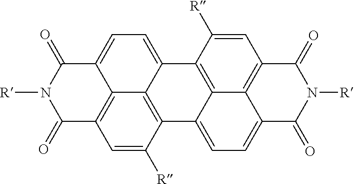

In yet another embodiment of the present disclosure in the general formula (III) the aromatic polycyclic conjugated molecule is a rylene fragment, R₁ is an electrically resistive substituent that provides resistivity to electric current and comprises hydrocarbon (saturated and/or unsaturated), fluorocarbon, siloxane, and/or polyethylene glycol as linear or branched chains located in terminal/apex positions, R₂ is a heteroatom functional group with at least one metal-coordinating heteroatom (neutral or anionic) located in terminal/apex positions. In one embodiment of the present disclosure, the rylene fragments in the general formula (III) are selected from the structures 17 to 37 as shown in Table 3.

TABLE 3
Examples of the rylene fragments

| | |
|---|---|
| 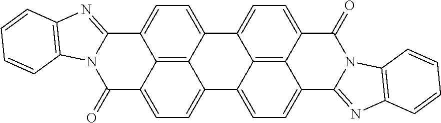 [SMILES: O=c1c2ccc3c4ccc5c6c(ccc(c7ccc(c2c37)c2nc3ccccc3n12)c46)c(=O)n1c2ccccc2nc51] | 17 |
| 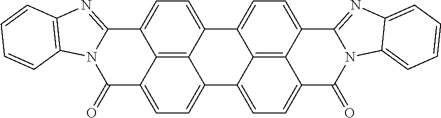 [SMILES: O=c1c2ccc3c4ccc5c(=O)n6c7ccccc7nc6c6ccc(c7ccc(c2c37)c2nc3ccccc3n12)c4c56] | 18 |
| 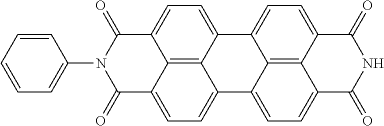 [SMILES: O=C1NC(=O)c2ccc3c4ccc5c6c(ccc(c7ccc1c2c73)c64)C(=O)N(c1ccccc1)C5=O] | 19 |
| 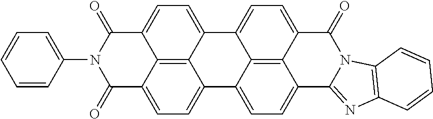 [SMILES: O=C1c2ccc3c4ccc5c(=O)n6c7ccccc7nc6c6ccc(c7ccc(c2c37)C(=O)N1c1ccccc1)c4c56] | 20 |
| 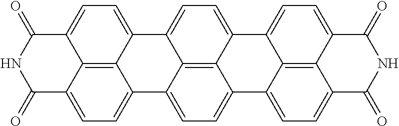 [SMILES: O=C1NC(=O)c2ccc3c4ccc5c6ccc7c8c(ccc(c9ccc(c%10ccc1c2c%103)c4c95)c86)C(=O)NC7=O] | 21 |
| 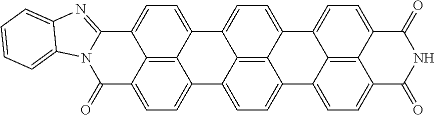 [SMILES: O=C1NC(=O)c2ccc3c4ccc5c6ccc7c8c(ccc(c9ccc(c%10ccc1c2c%103)c4c95)c68)c(=O)n1c2ccccc2nc71] | 22 |
| 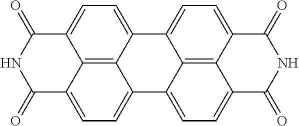 [SMILES: O=C1NC(=O)c2ccc3c4ccc5c6c(ccc(c7ccc1c2c73)c64)C(=O)NC5=O] | 23 |
| 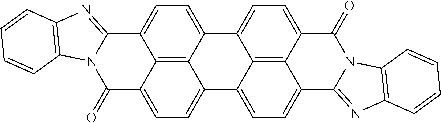 [SMILES: O=c1c2ccc3c4ccc5c6c(ccc(c7ccc(c2c37)c2nc3ccccc3n12)c46)c(=O)n1c2ccccc2nc51] | 24 |
| 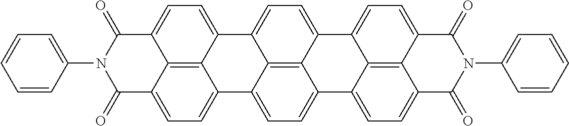 [SMILES: O=C1c2ccc3c4ccc5c6ccc7c8c(ccc(c9ccc(c%10ccc(c2c3%10)C(=O)N1c1ccccc1)c4c59)c86)C(=O)N(c1ccccc1)C7=O] | 25 |
| 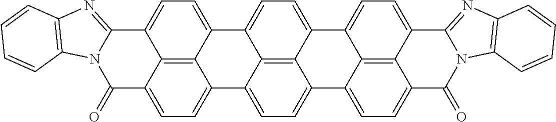 [SMILES: O=c1c2ccc3c4ccc5c6ccc7c(=O)n8c9ccccc9nc8c8ccc(c9ccc(c%10ccc(c2c3%10)c2nc3ccccc3n12)c4c59)c6c78] | 26 |
| 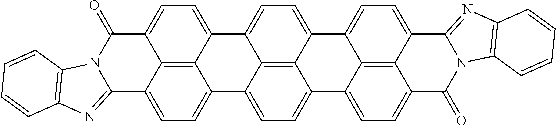 [SMILES: O=c1c2ccc3c4ccc5c6ccc7c8c(ccc(c9ccc(c%10ccc(c2c3%10)c2nc3ccccc3n12)c4c95)c68)c(=O)n1c2ccccc2nc71] | 27 |
| 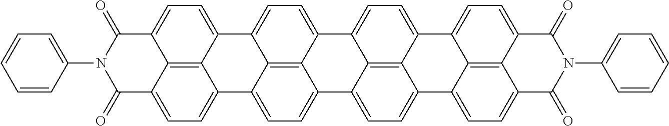 [SMILES: O=C1c2ccc3c4ccc5c6ccc7c8ccc9c%10c(ccc(c%11ccc(c%12ccc(c%13ccc(c2c3%13)C(=O)N1c1ccccc1)c4c5%12)c6c7%11)c%108)C(=O)N(c1ccccc1)C9=O] | 28 |
| 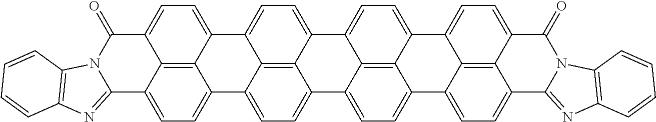 [SMILES: O=c1c2ccc3c4ccc5c6ccc7c8ccc9c(=O)n%10c%11ccccc%11nc%10c%10ccc(c%11ccc(c%12ccc(c%13ccc(c2c3%13)c2nc3ccccc3n12)c4c5%12)c6c7%11)c8c9%10] | 29 |
| 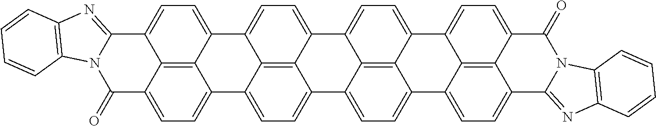 [SMILES: O=c1c2ccc3c4ccc5c6ccc7c8ccc9c%10c(ccc(c%11ccc(c%12ccc(c%13ccc(c2c3%13)c2nc3ccccc3n12)c4c5%12)c6c%117)c8%10)c(=O)n1c2ccccc2nc91] | 30 |
| 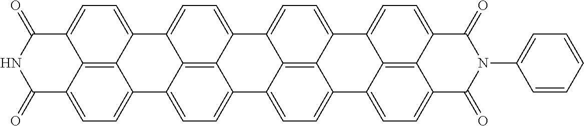 [SMILES: O=C1NC(=O)c2ccc3c4ccc5c6ccc7c8ccc9c%10c(ccc(c%11ccc(c%12ccc(c%13ccc1c2c%133)c4c%125)c6c%117)c%108)C(=O)N(c1ccccc1)C9=O] | 31 |
| 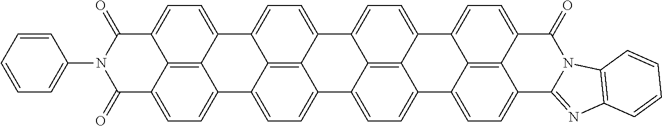 [SMILES: O=C1c2ccc3c4ccc5c6ccc7c8ccc9c(=O)n%10c%11ccccc%11nc%10c%10ccc(c%11ccc(c%12ccc(c%13ccc(c2c3%13)C(=O)N1c1ccccc1)c4c5%12)c6c7%11)c8c9%10] | 32 |
| 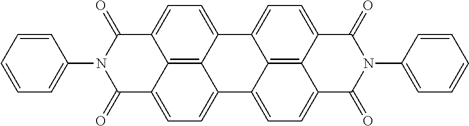 [SMILES: O=C1c2ccc3c4ccc5c6c(ccc(c7ccc(c2c37)C(=O)N1c1ccccc1)c64)C(=O)N(c1ccccc1)C5=O] | 33 |
| 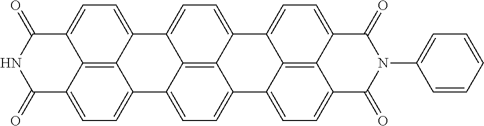 [SMILES: O=C1NC(=O)c2ccc3c4ccc5c6ccc7c8c(ccc(c9ccc(c%10ccc1c2c%103)c4c95)c86)C(=O)N(c1ccccc1)C7=O] | 34 |
| 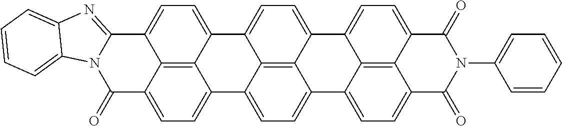 [SMILES: O=C1c2ccc3c4ccc5c6ccc7c(=O)n8c9ccccc9nc8c8ccc(c9ccc(c%10ccc(c2c3%10)C(=O)N1c1ccccc1)c4c59)c6c78] | 35 |
| 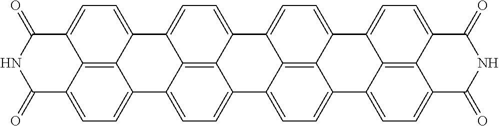 [SMILES: O=C1NC(=O)c2ccc3c4ccc5c6ccc7c8ccc9c%10c(ccc(c%11ccc(c%12ccc(c%13ccc1c2c%133)c4c%125)c6c%117)c%108)C(=O)NC9=O] | 36 |
| 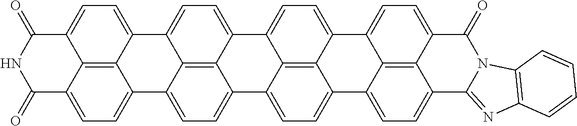 [SMILES: O=C1NC(=O)c2ccc3c4ccc5c6ccc7c8ccc9c%10c(ccc(c%11ccc(c%12ccc(c%13ccc1c2c%133)c4c%125)c6c%117)c8%10)c(=O)n1c2ccccc2nc91] | 37 |

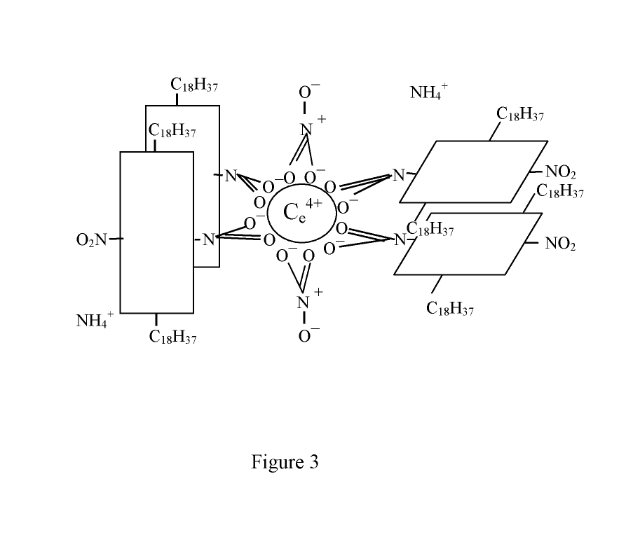

One example of an embodiment of the present invention, molecules of nitrate of perylene comprising two nitro-groups (—NO₂) located in lateral/bay positions and electrically resistive substituents (for example, C₁₈H₃₇) located in terminal/apex positions are used. These molecules form molecular stacks due to pi-pi interaction. These stacks will be coordinated to the Ce ion in planes orthogonal to one another. In this embodiment also ammonium cerium (IV) nitrate (NH₄⁺)₂Ce(NO₃)₆ in which anion [Ce(NO₃)₆)]²⁻ is neutralized by an ammonium cation NH₄⁺ is used. Nitro-groups of perylene replace four NO₃⁻-groups. The complex compound shown in FIG. 3 is as a result formed. Atoms of cerium are located between the stacks. Atoms of oxygen of the nitro-groups and NO₃⁻-groups form the first coordination sphere round this atom of cerium. The first coordination sphere and atom of cerium form complex anion with a charge of 2⁻. The electrically resistive substituents form the isolating cover (envelope) located around the atom of cerium and the coordination sphere. Cations of ammonium NH₄⁺ serve as counter-ions. These counter-ions provide an electro-neutrality of the complex compound and are situated outside the isolating envelope. The complex anion and counter-ions form an electric dipole of the disclosed complex compound. The value of the dipole may change owing to mobility of the counter-ions. The electron dense first coordination sphere of the disclosed complex compound is polarizable from an applied external electric field. It is necessary to notice that in the disclosed compound some types of interaction are realized: coordination bond, pi-pi interaction, ionic interaction and Van der Waals interaction.

In another embodiment of the present disclosure, the aromatic polycyclic conjugated molecule (Core) in the general formula (III) is tetrapirolic macro-cyclic fragment, R₁ is an electrically resistive substitute that provides resistivity to electric current and comprises hydrocarbon (saturated and/or unsaturated), fluorocarbon, siloxane, and/or polyethylene glycol as linear or branched chains, R₂ is a heteroatom functional group with at least one metal-coordinating heteroatom (neutral or anionic). In yet another embodiment of the present disclosure, the tetrapirolic macro-cyclic fragments have a general structural formula from the group comprising structures 38-44 as shown in Table 4, where M denotes an atom of four-valence metal.

TABLE 4
Examples of the tetrapirolic macro-cyclic fragments

| | |
|---|---|
| 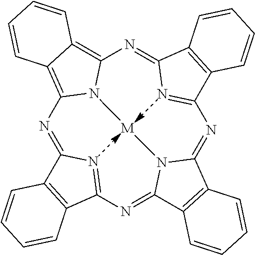 | 38 |
| 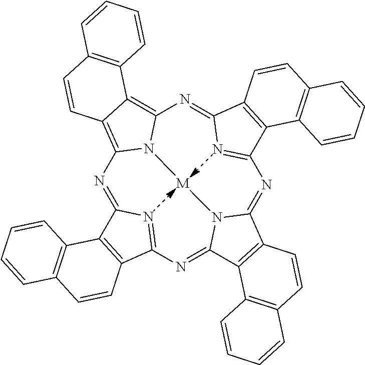 | 39 |
| 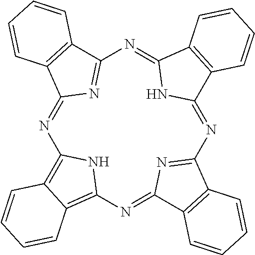 [SMILES: c1ccc2c(c1)-c1nc-2nc2[nH]c(nc3nc(nc4[nH]c(n1)c1ccccc41)-c1ccccc1-3)c1ccccc21] | 40 |
| 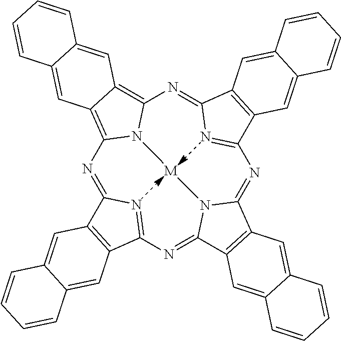 | 41 |
| 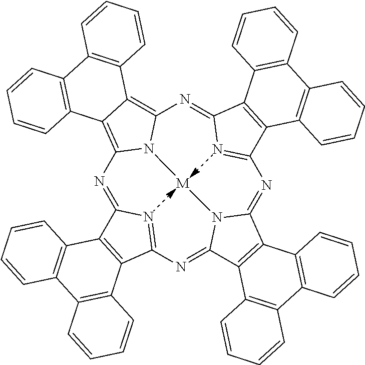 | 42 |
| 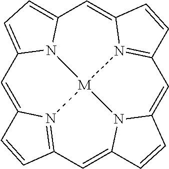 | 43 |
| 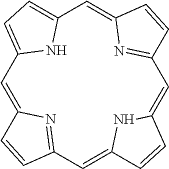 [SMILES: C1=Cc2cc3ccc(cc4nc(cc5ccc(cc1n2)[nH]5)C=C4)[nH]3] | 44 |

In still another embodiment of the present disclosure, the aromatic polycyclic conjugated molecule (Core) is phthalocyonine, R₁ is an alkyl chain, R₂ is anion of carboxylic group as the heteroatomic fragment. In yet another embodiment of the present disclosure, the complex compound has the following structure formula:

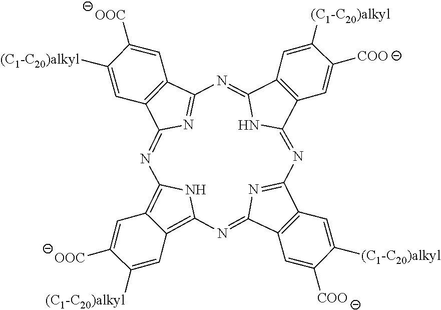

Molecules of oxygen on carboxyl groups take part in formation of the first coordination sphere round the complexing agent M. The electrically resistive fragments ((C₁-C₂₀)alkyl) create a dielectric cover round the complexing agent M and the first coordination sphere.

The present disclosure provides the solution comprising the electro-polarizable complex compound as disclosed above. In one embodiment of the present disclosure, the disclosed solution comprises the organic solvent selected from the list comprising ketones, carboxylic acids, hydrocarbons, cyclohydrocarbons, chlorohydrocarbons, alcohols, ethers, esters, and any combination thereof. In another embodiment of the present disclosure, the organic solvent is selected from the list comprising acetone, xylene, toluene, ethanol, methylcyclohexane, ethyl acetate, diethyl ether, octane, chloroform, methylene chloride, dichloroethane, trichloroethene, tetrachloroethene, carbon tetrachloride, 1,4-dioxane, tetrahydrofuran, pyridine, triethylamine, nitromethane, acetonitrile, dimethylformamide, dimethyl sulfoxide, and any combination thereof. In yet another embodiment of the present disclosure, the solution is a lyotropic liquid crystal solution.

The present disclosure provides the crystal meta-dielectric layer as disclosed above. In one embodiment of the present disclosure, the layer's relative permittivity is greater than or equal to 1000. In another embodiment of the crystal meta-dielectric layer, the real part of the relative permittivity (∈′) of the layer comprises first-order (∈⁽¹⁾), second-order (∈⁽²⁾) and third-order (∈⁽³⁾) permittivity according to follow formula:

∈′=∈⁽¹⁾+∈⁽²⁾·V₀/d+∈⁽³⁾·(V₀/d)²,

where V₀ is the DC-voltage which is applied to the crystal meta-dielectric layer, d is the layer thickness. In yet another embodiment of the present disclosure, the layer's resistivity is greater than or equal to 10¹³ ohm-cm.

The present disclosure provides the meta-capacitor comprising two metal electrodes positioned parallel to each other and which can be rolled or flat and planar and meta-dielectric layer between this electrodes. The layer comprises the electro-polarizable complex compounds as disclosed above. The polarizable atoms of the four-valence metals are placed into the resistive dielectric envelope formed by resistive fragments of the electrically resistive substituent where atoms of the four-valence metals, organic molecules of ligands, or heteroatoms have electronic or ionic type of polarizability.

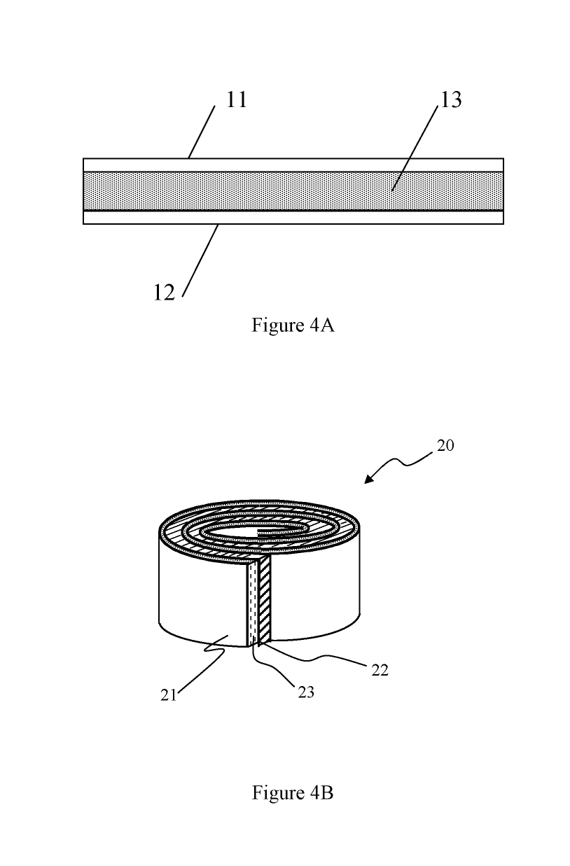

The meta-capacitor comprises a first electrode 11, a second electrode 12, and a meta-dielectric layer 13 disposed between said first and second electrodes as shown in FIG. 4A. The electrodes 11 and 12 may be made of a metal, such as copper, zinc, or aluminum or other conductive material and are generally planar in shape.

The electrodes 11, 12 may be flat and planar and positioned parallel to each other. Alternatively, the electrodes may be planar and parallel, but not necessarily flat, they may be coiled, rolled, bent, folded, or otherwise shaped to reduce the overall form factor of the capacitor. It is also possible for the electrodes to be non-flat, non-planar, or non-parallel or some combination of two or more of these. By way of example and not by way of limitation, a spacing d between the electrodes 11, 12 may range from about 100 nm to about 10,000 μm. The maximum voltage V_{bd} between the electrodes 11, 12 is approximately the product of the breakdown field E_{bd} and the electrode spacing d. If E_{bd}=0.1 V/nm and the spacing d between the electrodes 11 and 12 is 10,000 microns (100,000 nm), the maximum voltage V_{bd} would be 100,000 volts.

The electrodes 11, 12 may have the same shape as each other, the same dimensions, and the same area A. By way of example, and not by way of limitation, the area A of each electrode 11, 12 may range from about 0.01 m² to about 1000 m². By way of example and not by way of limitation, for rolled capacitors, electrodes up to, e.g., 1000 m long and 1 m wide.

These ranges are non-limiting. Other ranges of the electrode spacing d and area A are within the scope of the aspects of the present disclosure.

If the spacing d is small compared to the characteristic linear dimensions of electrodes (e.g., length and/or width), the capacitance C of the capacitor may be approximated by the formula:

C=∈∈₀A/d, (IV)

where ∈ₒ is the permittivity of free space (8.85×10⁻¹² Coulombs²/(Newton·meter²)) and E is the dielectric constant of the dielectric layer. The energy storage capacity U of the capacitor may be approximated as:

U=½∈∈ₒAE_{bd}² (V)

The energy storage capacity U is determined by the dielectric constant ∈, the area A, and the breakdown field E_{bd}. By appropriate engineering, a capacitor or capacitor bank may be designed to have any desired energy storage capacity U. By way of example, and not by way of limitation, given the above ranges for the dielectric constant ∈, electrode area A, and breakdown field E_{bd} a capacitor in accordance with aspects of the present disclosure may have an energy storage capacity U ranging from about 500 Joules to about 2·10¹⁶ Joules.

For a dielectric constant E ranging, e.g., from about 100 to about 1,000,000 and constant breakdown field E_{bd} between, e.g., about 0.1 and 0.5 V/nm, a capacitor of the type described herein may have a specific energy capacity per unit mass ranging from about 10 W·h/kg up to about 100,000 W·h/kg, though implementations are not so limited.

The present disclosure include meta-capacitors that are coiled, e.g., as depicted in FIG. 4B. In this example, a meta-capacitor 20 comprises a first electrode 21, a second electrode 22, and a meta-dielectric material layer 23 of the type described hereinabove disposed between said first and second electrodes. The electrodes 21, 22 may be made of a metal, such as copper, zinc, or aluminum or other conductive material and are generally planar in shape. In one implementation, the electrodes and meta-dielectric material layer 23 are in the form of long strips of material that are sandwiched together and wound into a coil along with an insulating material, e.g., a plastic film such as polypropylene or polyester to prevent electrical shorting between the electrodes 21, 22.

Certain aspects of the present disclosure will now be described more fully hereinafter with reference to the following examples, in which preferred embodiments of the present invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art.

### Example 1

This Example describes synthesis of the disclosed organic compound according following structural scheme:

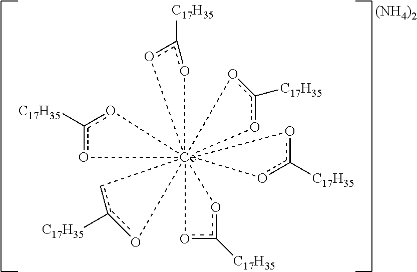

To obtain [Ce⁴⁺(Ste⁻)₄]ₓ, 0.50 g of Ce(OH)₄ was added 1.5 g of acetic acid and 2.05 g of stearic acid. The mixture was heated to 100° C. for 3 hours in an apparatus fitted with dry molecular sieves to absorb the water of condensation. The reaction was then placed under vacuum while heating to remove the rest of the condensed water and acetic acid, affording 2.38 g of yellow solid [Ce⁴⁺(Ste⁻)₄]ₓ.

To obtain Ce⁴⁺(Ste⁻)₄₊ₘ[N(but)⁺₄]ₘ, 1.00 g of the above [Ce⁴⁺(Ste⁻)₄]ₓ was added 5 mL of toluene, 0.447 g of stearic acid, and 2.147 g of a 20% solution of TBA-OMe in methanol. The suspension was heated to 50° C. for 30 minutes, and then the residual solvents were removed under reduced pressure at 50° C. until there was no more weight loss, yielding 1.83 g Ce⁴⁺(Ste⁻)₄₊ₘ[N(but)⁺₄]ₘ.

### Example 2

This Example describes synthesis of a disclosed organic compound according following structural scheme:

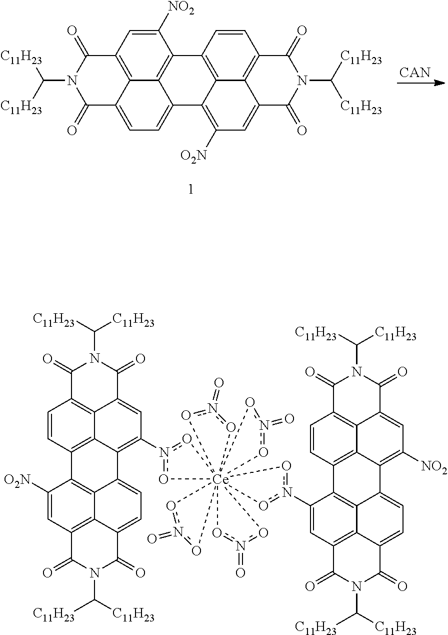

Perylene bisimide (1, 2.7 g, 2.4 mmol) was dissolved in 20 mL of THF. Then, Cerric ammonium nitrate (CAN, 0.219 g, 0.4 mmol) was dissolved in a minimum amount of MeOH and added to the THF solution. The mixture was stirred overnight at 40° C., and filtered to give 2.7 g of Ce⁴⁺(NO₃)₄(1)

### Example 3

This Example describes synthesis of a disclosed organic compound according following structural scheme:

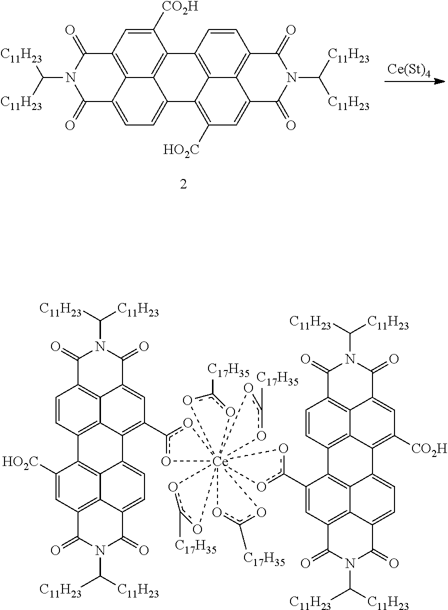

Cerium(IV) stearate (synthesis shown in Example 1) (CeSt₄, 1 equiv.) and 2 (1 equiv.) were dissolved in CHCl₃.

While the present disclosure includes a complete description of the preferred embodiment of the present invention, it is possible to use various alternatives, modifications and equivalents. Therefore, the scope of the present invention should be determined not with reference to the above description but should, instead, be determined with reference to the appended claims, along with their full scope of equivalents. Any feature described herein, whether preferred or not, may be combined with any other feature described herein, whether preferred or not. In the claims that follow, the indefinite article “A”, or “An” refers to a quantity of one or more of the item following the article, except where expressly stated otherwise. As used herein, in a listing of elements in the alternative, the word “or” is used in the logical inclusive sense, e.g., “X or Y” covers X alone, Y alone, or both X and Y together, except where expressly stated otherwise. Two or more elements listed as alternatives may be combined together. The appended claims are not to be interpreted as including means-plus-function limitations, unless such a limitation is explicitly recited in a given claim using the phrase “means for.”

1. An electro-polarizable complex compound having the following general formula:
[M⁴⁺(L)ₘ]ₓKₙ, (I)
where M is a four-valence metal complexing agent, ligand L is a first ligand having one or more heteroatomic fragments comprising one or more neutral or anionic metal-coordinating heteroatoms and one or more electrically resistive fragments, m represents the number of ligands, x represents the oxidative state of the metal-ligand complex, K is a counter-ion or zwitterionic polymer which provides an electro-neutrality of the complex compound, n represents the number of counter-ions or zwitterionic polymers, wherein said one or more neutral or anionic metal-coordinating heteroatoms form a first coordination sphere, and the number of heteroatoms in this first coordination sphere does not exceed 12.

2. The complex compound according to claim 1, wherein the four-valence metal is selected from the set comprising cerium, thorium, lead, titanium, zirconium, tin, palladium, platinum, osmium, iridium, germanium, manganese, and hafnium.

3. The complex compound according to claim 1, wherein the electrically resistive fragment provides resistivity to electric current and comprises hydrocarbon (saturated and/or unsaturated), fluorocarbon, siloxane, and/or polyethylene glycol as linear or branched chains.

4. The complex compound according to claim 1, wherein the electrically resistive fragments are cross-linked.

5. The complex compound according to claim 1, wherein the electrically resistive fragments are fluorinated.

6. The complex compound according to claim 1, wherein K is N⁺R₄, where R is hydrogen (H), Fluorine (F) or an alkyl group.

7. The complex compound according to claim 1, wherein the counter-ion is selected from one or multiple ionic groups from the class of ionic compounds that are used in ionic liquids connected directly or via a connecting group to at least one ligand.

8. The complex compound according to claim 7, wherein at least one ionic group is selected from the list comprising [NR₄]⁺, [PR₄]⁺ as cation and [—CO₂]⁻, [—SO₃]⁻, [—SR₅]⁻, [—PO₃R]⁻, [—PR₅]⁻ as anion, wherein R is selected from the set comprising hydrogen (H), alkyl, and fluorine.

9. The complex compound according to claim 7, wherein at least one connecting group is selected from the set comprising CH₂, CF₂, SiR₂O, CH₂CH₂O, wherein R is selected from the hydrogen (H), alkyl, and fluorine.

10. The complex compound according to claim 7, wherein at least one connecting group is selected from structures 1-9, where X is hydrogen (H) or an alkyl group:

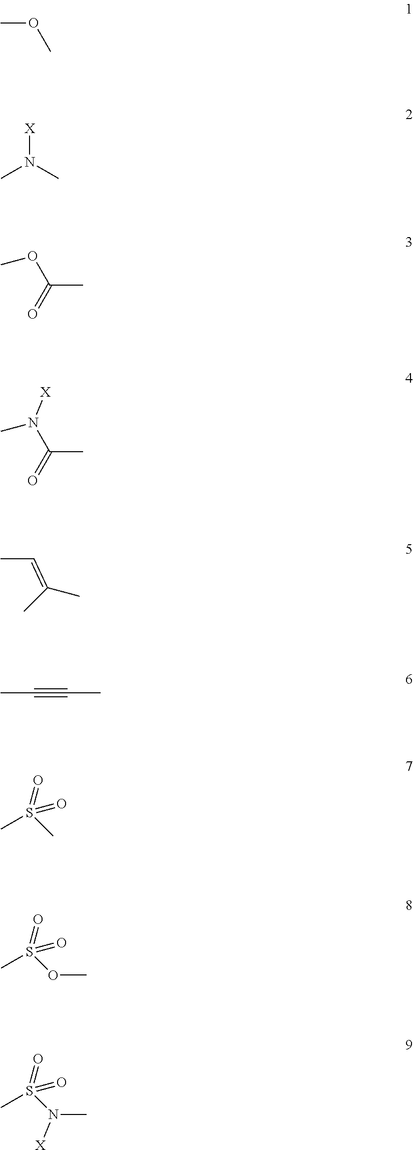

11. The electro-polarizable compound according to claim 1, wherein the at least one connecting group is selected from structures 11 to 16:

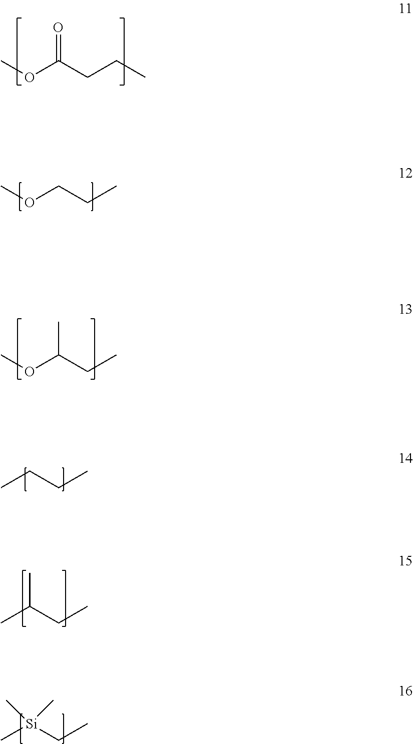

12. The complex compound according to claim 1, wherein the counter-ion is selected from one or multiple ionic groups from the class of ionic compounds that are zwitterionic polymers.

13. The complex compound according to claim 12, wherein the zwitterionic polymer is N-Dodecyl-N,N-(dimethylammonio)butyrate having the following structural formula: 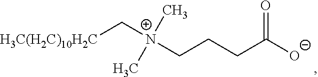
wherein two atoms of oxygen of carboxyl group take part in formation of the first coordination sphere and the cation N⁺ serves as a counter-ion.

14. The complex compound according to claim 1, having the following general formula:
Ce⁴⁺(Ste⁻)₄₊ₘ[N(but)⁺₄]ₘ, (II)
where m≧2; Ste is anion of stearic acid comprising atoms of oxygen as heteroatoms and an electrically resistive alkyl chain as the resistive fragment, and N(but)⁺₄ is a cation of tetrabutyl ammonium.

15. The complex compound according to claim 1, wherein the ligand L has the following general formula:
(R₁)ₖ-Core-(R₂)ₚ, (III)
where Core is an aromatic polycyclic conjugated anisotropic molecule, R₁ is an electrically resistive substituent that includes saturated and/or unsaturated hydrocarbon, fluorocarbon, siloxane, and/or polyethylene glycol as linear or branched chains, R₂ is a substitute comprising the one or more neutral or anionic metal-coordinating heteroatoms, k=1, 2, 3, and 4, p=1, 2, 3, 4, 5, 6, 7, and 8, wherein said aromatic polycyclic conjugated molecule (Core) forms supramolecules in the suitable solvent.

16. The complex compound according to claim 15, wherein the aromatic polycyclic conjugated molecule is a rylene fragment, R₁ is an electrically resistive substituent that provides resistivity to electric current and comprises hydrocarbon (saturated and/or unsaturated), fluorocarbon, siloxane, and/or polyethylene glycol as linear or branched chains located in terminal/apex positions, R₂ is a heteroatom functional group with one or more neutral or anionic metal-coordinating heteroatoms located in lateral or bay positions.

17. The complex compound according to claim 15, wherein the aromatic polycyclic conjugated molecule is a rylene fragment, R₁ is an electrically resistive substituent that includes saturated and/or unsaturated hydrocarbon, fluorocarbon, siloxane, and/or polyethylene glycol as linear or branched chains located in terminal/apex positions, R₂ is a heteroatom functional group with one or more neutral or anionic metal-coordinating heteroatom located in terminal or apex positions.

18. The complex compound according to any of claim 16 or 17, wherein the rylene fragments are selected from structures 17 to 37.

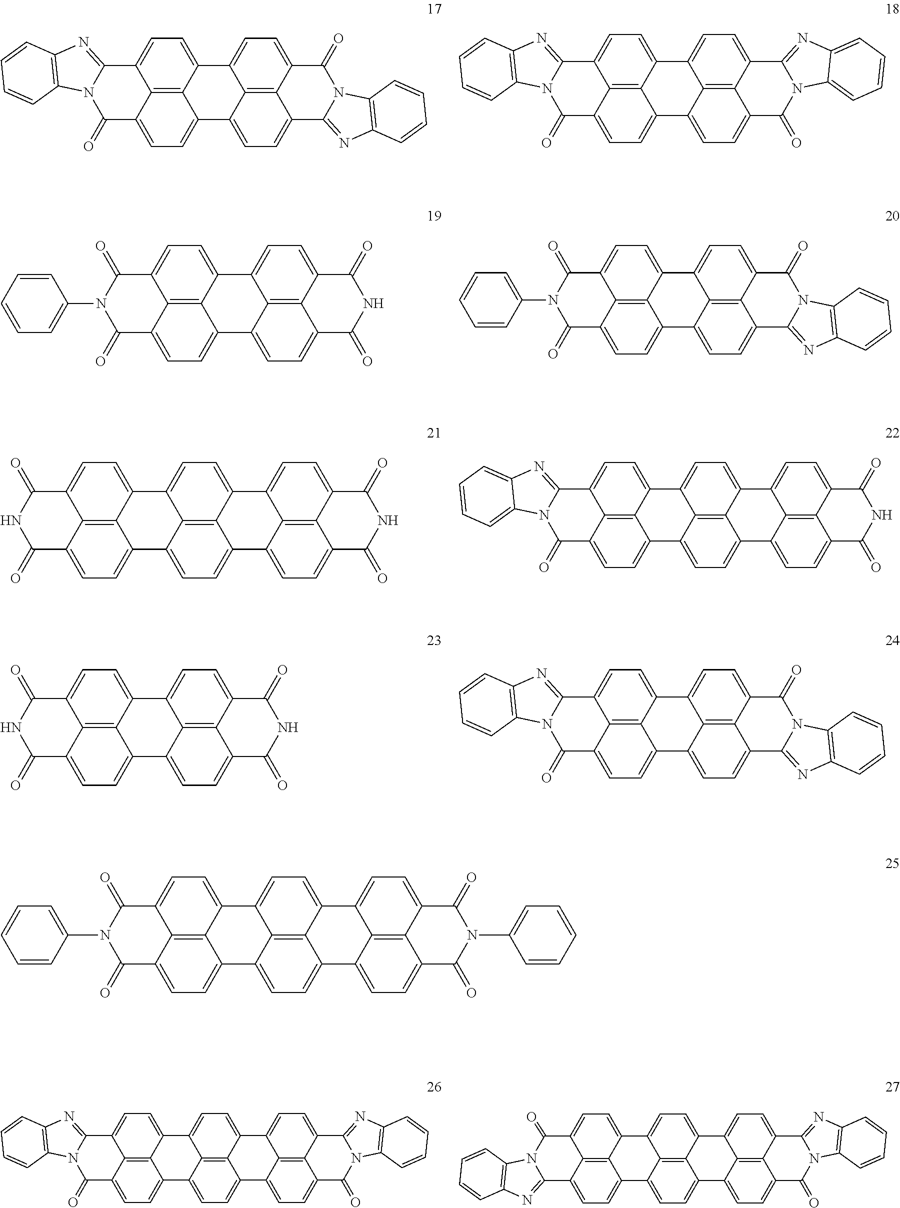

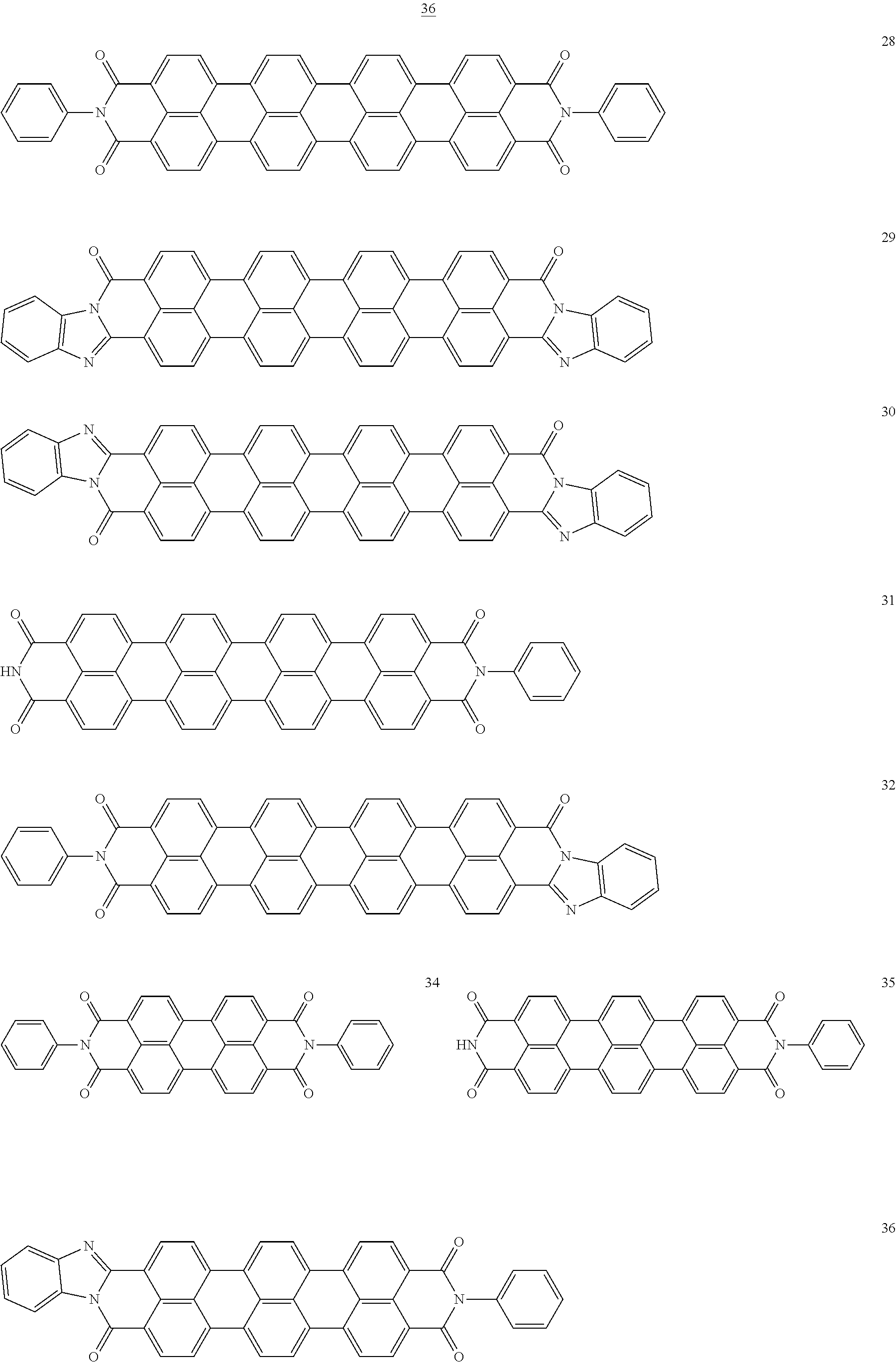

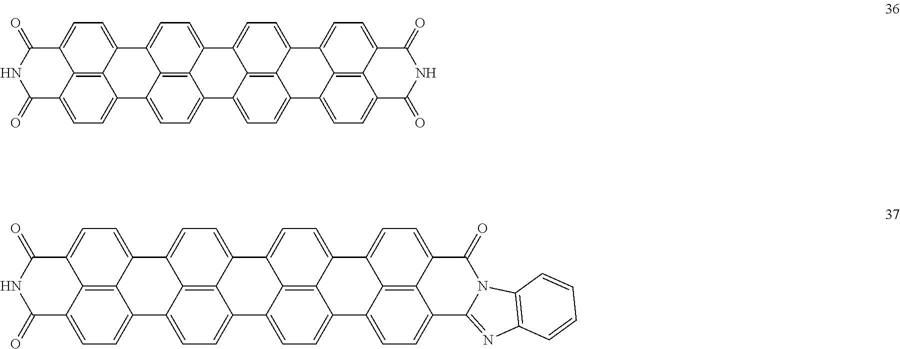 [SMILES: O=C1NC(=O)c2ccc3c4ccc5c6ccc7c8ccc9c%10c(ccc(c%11ccc(c%12ccc(c%13ccc1c2c%133)c4c%125)c6c%117)c%108)C(=O)NC9=O ; O=C1NC(=O)c2ccc3c4ccc5c6ccc7c8ccc9c%10c(ccc(c%11ccc(c%12ccc(c%13ccc1c2c%133)c4c%125)c6c%117)c8%10)c(=O)n1c2ccccc2nc91]

19. The complex compound according to claim 15, wherein the aromatic polycyclic conjugated molecule (Core) is tetrapirolic macro-cyclic fragment, R₁ is an electrically resistive substitute that provides resistivity to electric current and comprises hydrocarbon (saturated and/or unsaturated), fluorocarbon, siloxane, and/or polyethylene glycol as linear or branched chains, R₂ is a heteroatom functional group with one or more neutral or anionic metal-coordinating heteroatom.

20. The complex compound according to claim 19, wherein the tetrapirolic macro-cyclic fragments have a general structural formula from the group of structures 38-44, where M denotes an atom of four-valence metal:

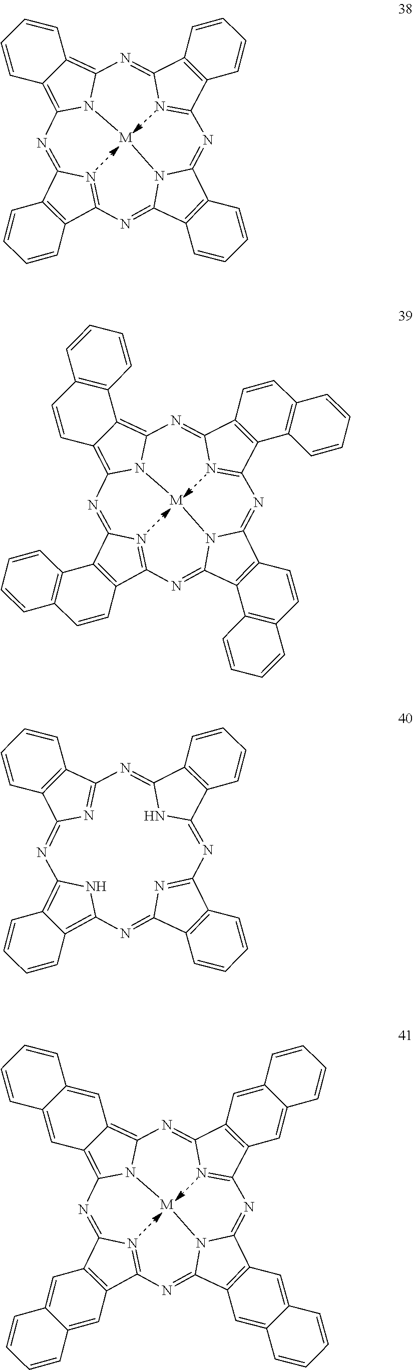

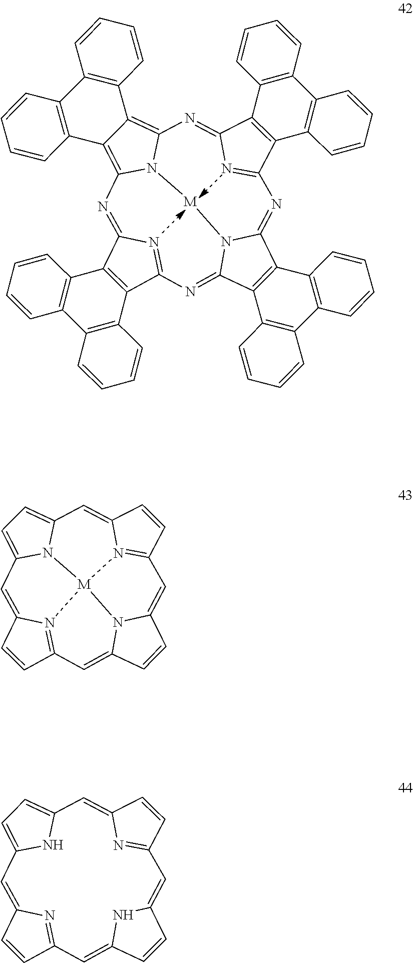

21. The complex compound according to claim 15, wherein the aromatic polycyclic conjugated molecule (Core) is phthalocyonine, R₁ is an alkyl chain, R₂ is anion of carboxylic group as a heteroatomic fragment containing the one or more neutral or anionic metal-coordinating heteroatoms.

22. The complex compound according to claim 21 has the following structure formula:

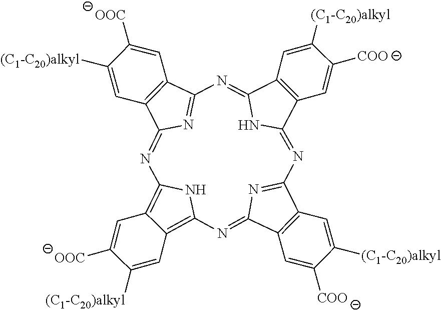

23. A solution comprising an organic solvent and at least one electro-polarizable complex compound according to claim 1.

24. The solution according to claim 23, wherein the organic solvent is selected from the list comprising ketones, carboxylic acids, hydrocarbons, cyclohydrocarbons, chlorohydrocarbons, alcohols, ethers, esters, and any combination thereof.

25. The solution according to claim 23, wherein the organic solvent is selected from the list comprising acetone, xylene, toluene, ethanol, methylcyclohexane, ethyl acetate, diethyl ether, octane, chloroform, methylenechloride, dichloroethane, trichloroethene, tetrachloroethene, carbon tetrachloride, 1,4-dioxane, tetrahydrofuran, pyridine, triethylamine, nitromethane, acetonitrile, dimethylformamide, dimethyl sulfoxide, and any combination thereof.

26. The solution according to claim 23, wherein the solution is a lyotropic liquid crystal solution.

27. A crystal meta-dielectric layer comprising a mixture of the electro-polarizable complex compounds according to claim 1.

28. The crystal meta-dielectric layer of claim 27, wherein the four-valence metals are placed into a resistive dielectric envelope formed by the one or more electrically resistive fragments wherein atoms of the four-valence metals, the organic molecules of the ligands, or the one or more neutral or anionic metal-coordinating heteroatoms have electronic or ionic type of polarizability.

29. The crystal meta-dielectric layer of claim 27, wherein the layer's relative permittivity is greater than or equal to 1000.

30. The crystal meta-dielectric layer of claim 27, wherein the layer's resistivity is greater than or equal to 10¹³ ohm-cm.

31. A meta-capacitor comprising two metal electrodes positioned parallel to each other and which are rolled or flat and planar and a meta-dielectric layer between the two electrodes, wherein the meta-dielectric layer comprises the electro-polarizable complex compounds according to claim 1.

32. The meta-capacitor of claim 31, wherein polarizable atoms of the four-valence metals are placed into a resistive dielectric envelope formed by the one or more electrically resistive fragments where atoms of the four-valence metals, organic molecules of ligands, or the heteroatoms have electronic or ionic type of polarizability.

33. The complex compound of claim 1, the complex compound having an at least one second ligand, the second ligand having different structure than the first ligand and wherein the second ligand is part of the first coordination sphere.
